(19) United States
(12) Patent Application Publication
(10) Pub. No.: US 2007/0061837 A1
(43) Pub. Date: Mar. 15, 2007

(54) System and method for software driven advertising

(76) Inventor: Shay Dadush, Rishon le zion (IL)

Correspondence Address: OSTROLENK FABER GERB & SOFFEN, 1180 AVENUE OF THE AMERICAS, NEW YORK, NY, 100368403, US

(21) Appl. No.: 11/226,808

(22) Filed: Sep. 14, 2005

(51) Int. Cl. H04N 7/025; H04N 7/10

(52) U.S. Cl. 725/34; 725/35

(57) ABSTRACT

The present invention includes a system and method for providing active advertising for businesses or organizations. In a preferred embodiment, a particular audience is identified for being most likely to respond to an offer, and advertisements are developed, adjusted and placed accordingly. Preferably, a plurality of variables are identified, including a particular format, time of day for display, various objectives of the campaign, and a respective audience, and an algorithm is employed which uses the variables to determine an effective and influential advertisement.

### BACKGROUND OF THE INVENTION

1. Field of the Invention

The present invention relates generally to advertising and, more particularly, to managing advertisement via the internet.

2. Description of the Related Art

Advertising continues to generate a significant source of revenue for many businesses and organizations. Introducing businesses, products and services to consumers is, typically, critical for any successful business.

In the prior art, advertising is broadcast on radio, television and distributed in print. While these media are effective at reaching a percentage of the consumer population, many consumers are not introduced to or reminded of new and existing businesses, products and services. Further, these prior art forms of advertisement are considered herein to be “passive.” In other words, an advertisement campaign is developed and distributed without frequent and continual updates, input and adjustments.

As technology has evolved over time, forms of advertising have similarly changed to maximize income potential directly related to consumers' awareness of goods and/or services.

One notable way businesses introduce new products and services to consumers is by exhibiting images on large-screen displays. The price of large screen monitors, for example, cathode ray tube (“CRT”), liquid crystal display (“LCD”), projection displays and plasma monitors, continues to fall and, therefore, become financially affordable to more and more businesses that strive to educate consumers of goods/services offered for sale. Accordingly, the use of monitors and various kinds of displays continues to increase, particularly as the cost of the various kinds of displays falls. Accordingly, the use of monitors and various display screens increases in many businesses. The use of display screens for advertising and promotional purposes is found in many kinds of retail and service industries in order to capture the attention of passersby and people present in the particular establishment where the display(s) are installed.

As known to one skilled in the art, investing in an installation of one or more monitors in a particular establishment raises an issue regarding the content to be displayed thereon. In the prior art, advertising companies contract their services to provide business with content for variously sized CRT, LCD and plasma monitors installed in various locations. For example, an advertising company will visit a retail clothing store establishment and, after receiving and/or generating video content of models wearing various items for sale, generate a relatively short video that repeats (“loops”) continuously as it is played. The clothing retailer plays the video in a centrally located device, for example, a video cassette recording/player, and the video is displayed on one or more monitors installed in or near the establishment for customers and/or passersby. A shortcoming exists in that the same content is repeatedly displayed, and new content, which may be immediately required by a customer, is not available.

Moreover, contracting the services of an advertising company to produce a relatively short video is typically expensive. Further, as inventory changes and/or needs arise for updating advertisements, new videos and/or advertising content are often required. Updating an advertising campaign frequently over time is referred herein to be “active” and is believed to be significantly more effective than passive advertising.

### SUMMARY OF THE INVENTION

The present invention improves upon prior art passive advertising. In one embodiment, the present invention includes a method for composing an advertisement. The method includes storing on an information processor an advertisement template file operable to incorporate content received from a user. A user interface is preferably provided that is operable for a user to select the advertisement template file, transmit content to the information processor to be included in the advertisement template file for the advertisement, preview the advertisement and/or save the advertisement. The method further comprises receiving from a user the content to be included in the advertisement, and storing the received content on the information processor. The content is preferably incorporated in the template to generate the advertisement, and the advertisement is provided on a display device such that the advertisement is available for display substantially immediately.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement in a preferred embodiment of the present invention;

FIG. 2 illustrates the functional elements of a user terminal and/or information processor;

FIG. 3 shows a plurality of templates that are provided and are selectable by a user for creating and/or editing an advertisement;

FIG. 4 shows an example display screen that is preferably displayed to a customer after a template has been selected;

FIG. 5 illustrates the ability for a customer to incorporate multi-media content in an advertisement;

FIG. 6 illustrates and example display screen that shows an example advertisement; and

FIGS. 7A-7D illustrate example table structures that are used in an embodiment of the present invention.

### DESCRIPTION OF THE PREFERRED EMBODIMENT

The present invention includes a system and method for providing active advertising for businesses or organizations. In a preferred embodiment, a particular audience is identified for being most likely to respond to an offer, and advertisements are developed, adjusted and placed accordingly. Preferably, a plurality of variables are identified, including a particular format, time and/or day for display, various objectives of the campaign, and a respective audience, and an algorithm is employed which uses the variables to determine an effective and influential advertisement. Thereafter, in one embodiment, a template is provided which represents a structure for an advertisement. A user preferably selects a template, and modifies the template by adding text, images or the like. The modified template can be saved for future use, and, thereafter, can be updated as desired by a customer, thereby enabling customized, active advertisements substantially immediately which are available upon demand.

In one embodiment, a series of templates is provided, each of which represents a particular advertisement layout and arrangement of imagery, audio and/or video. A user selects a particular template and modifies the template by adding textual data, pictorial data, moving image data (e.g., MACROMEDIA FLASH vector movies) and/or audio data. Thereafter, the modified template is saved as an advertisement, and is available for immediate use in an advertisement that is preferably displayable via one or more monitors, such as CRT monitors, LCD monitors, projection displays and/or plasma screen monitors. The original template can be reused to produce another, new and, typically, different advertisement.

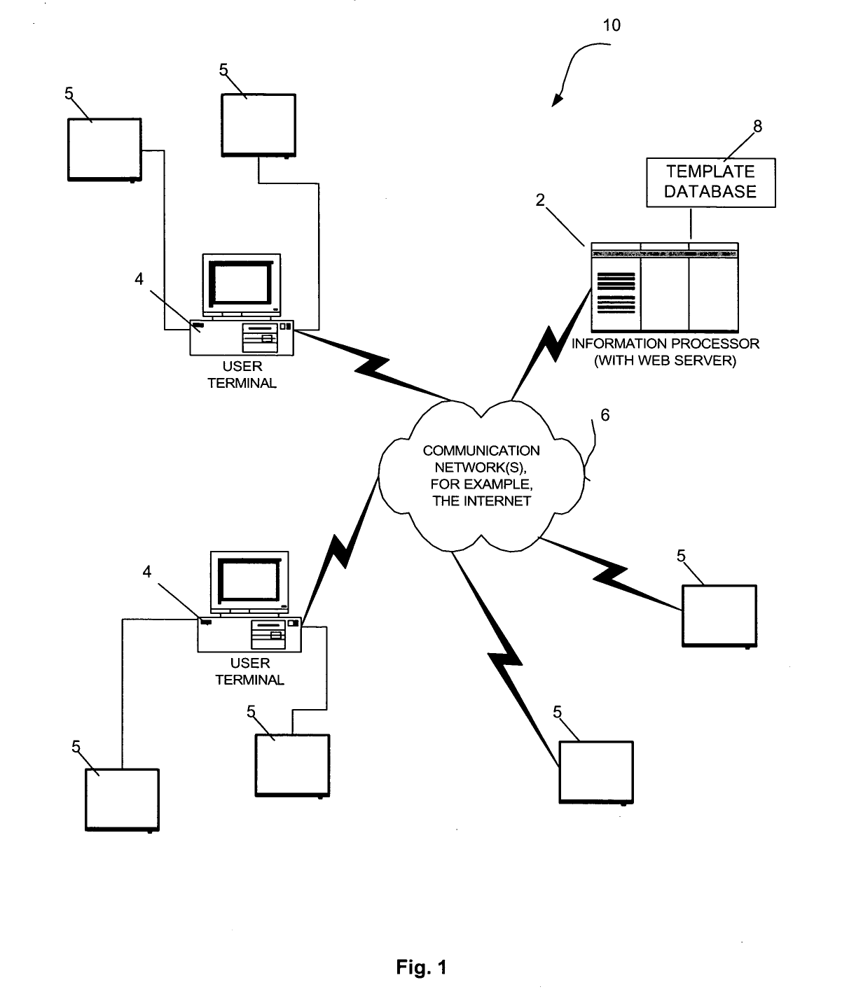

Referring to the drawings, in which like reference numerals refer to like elements, FIG. 1 shows an example hardware arrangement in a preferred embodiment of the present invention, including a hardware arrangement for providing active advertisements, and referred to generally as system 10. In the embodiment shown in FIG. 1, system 10 comprises at least one information processor 2 (configured to operate as a internet web server) adapted to access communication network 6 and communicate with user terminals 4. One or more user terminals preferably control operation of monitors 5 which may comprise televisions, monitors, projection devices, or other display devices. Preferably, monitors 5 interface with user terminals via the known communications protocol, Transmission Control Protocol/Internet Protocol “TCP/IP”, thereby enabling a display of advertisements as a function of a communication network, such as the internet. In this way, content can be transmitted to a monitor 5 via TCP/IP, enabling an execution of commands to display content on monitors 5 over the internet. Moreover, one or more monitors 5 may be associated with an IP address. In this way, each of a plurality of monitors 5 can show respective advertisements directed to particular audiences, and changes to content can be effected from remote locations.

Moreover, although the embodiment shown in FIG. 1 shows monitors 5 coupled to user terminals 4, the invention is not so limited. One skilled in the art will recognize that one or more of monitors 5 may be coupled to any device, including other monitors 5, in order to display advertisements and other content in accordance with the teachings herein.

In the example shown in FIG. 1, information processor 2 preferably provides template database 8, which includes one more advertisement templates in accordance with the teachings herein. As described below in greater detail, template database includes one or more data tables and programming routines.

As used herein, the term, “module” refers, generally, to one or more discrete components that contribute to the effectiveness of the present invention. Modules can operate or, alternatively, depend upon one or more other modules in order to function.

Information processor 2 and user terminals 4 are any devices that are capable of sending and receiving data across communication network 6, e.g., mainframe computers, mini computers, personal computers, laptop computers, a personal digital assistants (PDA) and internet access devices such as Web TV. In addition, information processors 2 and user terminals 4 are preferably equipped with a web browser, such as MICROSOFT INTERNET EXPLORER, NETSCAPE NAVIGATOR, MOZILLA FIRREFOX or the like. Thus, as envisioned herein, information processor 2 and/or user terminals 4 are devices that can communicate over a network and can be operated anywhere, including, for example, moving vehicles.

The nature of the present invention is such that one skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA server pages, servlets, and a plurality web site development applications.

For example, data may be configured as a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or a plurality of sources. For example, an image file may be received over a communication network that includes advertisement information. The advertisement information is preferably automatically determined and stored in template database 8. In another example, data are received that are provided in a particular format (e.g., MICROSOFT EXCEL), and programming routines are executed that convert the data to another formatted (e.g., ASCII comma-delimited text).

It is contemplated herein that any suitable operating system can be used on user terminals 4 and information processor 2, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC or any other suitable operating system. Further, in a preferred embodiment, MACROMEDIA FLASH is employed for providing advertisements displayable on monitors 5. Of course, one skilled in the art will recognize that other software applications are available in accordance with the teachings herein, including, for example, via JAVA, JAVA Script, Action Script, Swish, or the like.

Moreover, a plurality of data file types are envisioned herein. For example, the present invention preferably supports various suitable multi-media file types, including (but not limited to) JPEG, BMP, GIF, TIFF, MPEG, AVI, SWF, RAW or the like (as known to those skilled in the art).

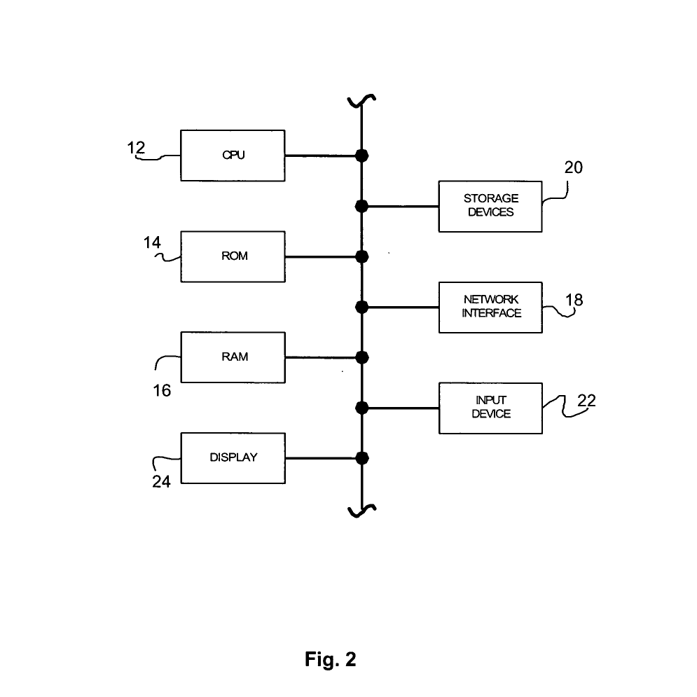

FIG. 2 illustrates the functional elements of user terminal 4 and/or information processor 2 and include one or more central processing units (CPU) 12 used to execute software code and control the operation of user terminal 4, read-only memory (ROM) 14, random access memory (RAM) 16, one or more network interfaces 18 to transmit and receive data to and from other computing devices across a communication network, storage devices 20 such as a hard disk drive, floppy disk drive, tape drive, CD ROM or DVD for storing program code, databases and application data, one or more input devices 22 such as a keyboard, mouse, track ball, microphone and the like, and a display 24.

The various components of information processor 2 and/or user terminal 4 need not be physically contained within the same chassis or even located in a single location. For example, storage device 20 may be located at a site which is remote from the remaining elements of information processor 2 or user terminal 4, and may even be connected to CPU 12 across communication network 6 via network interface 18. Information processor 2 preferably includes a memory equipped with sufficient storage to provide the necessary databases, forums, and other community services as well as acting as a web server for communicating hypertext markup language (HTML), FLASH, Action Script, Java, Active Server Pages, Active-X control programs on user terminals 4. Information processors 2 are arranged with components, for example, those shown in FIG. 2, suitable for the expected operating environment of information processor 2. The CPU(s) 12, network interface(s) 18 and memory and storage devices are selected to ensure that capacities are arranged to accommodate expected demand.

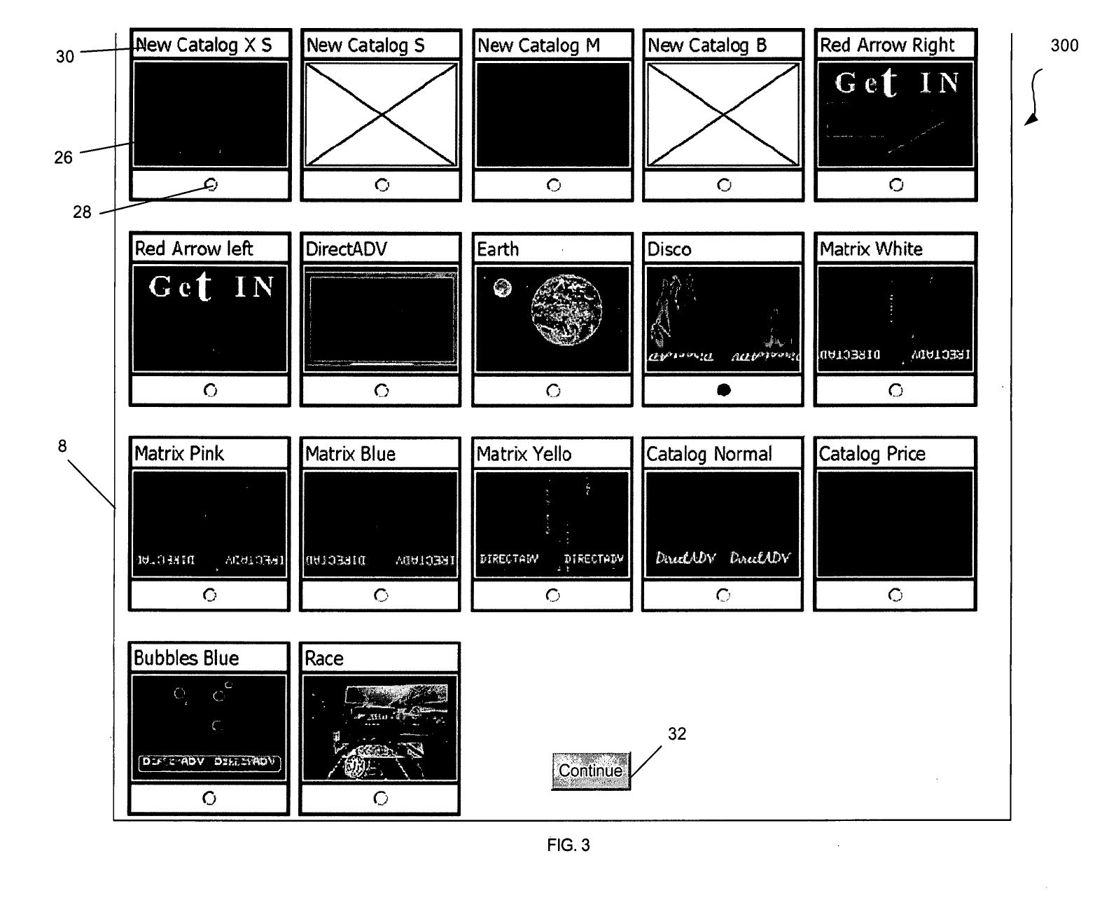

Referring now to FIG. 3, an example display screen 300 is provided that displays at least some contents of template database 8. As shown in FIG. 3, a plurality of templates 26 are provided which are selectable by a user for creating and/or editing an advertisement. As shown in FIG. 3, a plurality of templates 26 are presented for a user to select. Each template 26 has a graphic screen control 28, such as a radio button, which preferably enables a user to select a respective template 26 for creating an advertisement. Further, each template 26 preferably includes a title 30 that provides a unique identifier for a respective template. Each template 26 is preferably distinct in some way, for example, in accordance with a particular look and feel. One template 26 shown in FIG. 3 shows a representation of an automobile race, while another template 26 shown in FIG. 3 shows a representation of planet Earth.

In a preferred embodiment of the present invention, a plurality of categories of users of the present invention are envisioned. One category of user, referred to herein, generally, as a customer, uses the present invention to create advertisements for his business or organization. Another category of user, referred to herein, generally, as an administrative user, performs administrative functions with respect to the invention. For example, an administrative user preferably manages template database 8, corresponding software programs, customer access to the database, or the like.

In a preferred embodiment of the present invention, customers do not create templates 26. Instead, templates 26 are preferably made available to customers for use to generate advertisements, therefrom. Preferably, a customer identifies particular information regarding his business or organization, the audience whom he would like to reach with the advertisements, the time the advertisements will be displayed, etc. Thereafter, an administrative user uses the present invention to generate a template for the customer. The customer accesses display screen 300 to select a particular template that captures a particular look and feel of the advertisement the customer desires, and, thereafter, the customer preferably adds content to the template to produce an advertisement that is ready for display to an audience. This process is referred to herein, generally, as customizing a template.

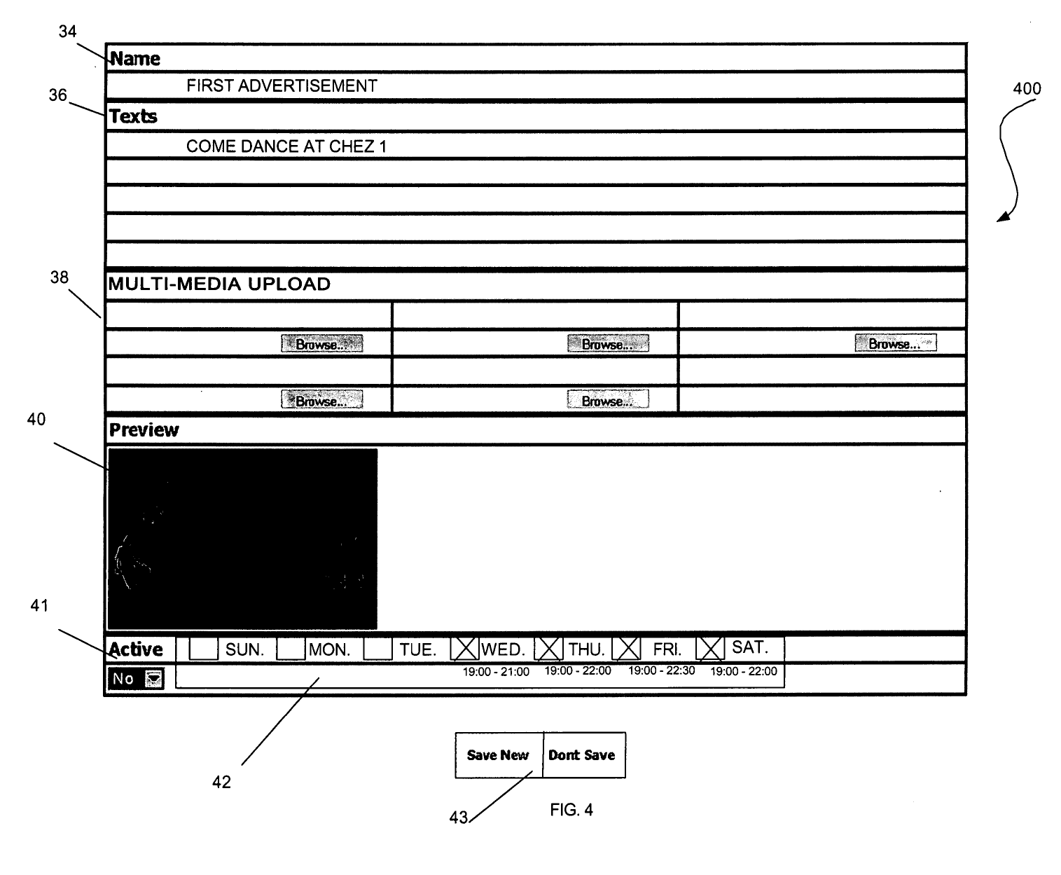

Preferably, after a user customizes a template to produce an advertisement, the advertisement is not, thereafter, usable as a template 26. Preferably, after a customer customizes a template to produce an advertisement, the advertisement can continue to be modified according to the customer's desires. However, in the preferred embodiment, the template itself cannot be used to generate additional advertisements that include the characteristics (e.g., text, images, audio and/or video) that are provided by the customer during the process of generating the advertisement. Although such changes in templates are preferably not permissible, the present invention offers substantial flexibility to customers. For example, in a preferred embodiment (and shown in the example display of FIG. 4), a plurality of graphic image files (e.g., JPEG files) can be transmitted by a customer to information processor 2 to be incorporated into a template. The plurality of images are preferably displayed in a sequence, such as a “slide show,” in an order defined by the user. Moreover, a sequence of templates can preferably be defined to generate advertisements that are displayed in sequence, thereby providing a sequence of advertisements. For example, a store wants to advertise its catalogue of fifteen items. Accordingly, a template is selected for the advertisement, and five of the fifteen items are uploaded for a first advertisement. Continuing with this example, the same template is selected again, and another five (of the fifteen) items are uploaded, and a second advertisement is generated. Thereafter, the same template is selected again, and another five (of the fifteen) items are uploaded and applied to a third advertisement. Thereafter, the three advertisements are displayed sequentially, and, accordingly, all fifteen items in the store catalogue are displayed.

Thus, in a preferred embodiment, customers are able to upload content to information processor 2 to be incorporated in template 26, but are not able to modify properties of template 26, such as the template's 26 colors, layout, fonts, or the like. Of course, one skilled in the art will recognize that alternative embodiments are possible and envisioned herein without departing from the spirit and scope of the invention. For example, limited modifications to a template, or even complete modifications to a template may be allowed to be made by users of the present invention. Although such alternative embodiments are envisioned, it is preferred that users are not provided with an interface to modify templates (such as described above) because users are not considered to be, typically, well-versed in the advertisement industry. For example, a user of the present invention who sells clothing is believed to be skilled in the art of making and selling clothes, but not in the nuances advertisements, such as providing moving images on a large screen plasma television. It is for this reason that people in the prior art solicit advertising agencies to provide commercial advertising. The present invention, as described above, improves upon the prior art by eliminating the need for an advertising agency, while delivering dynamic and active professional advertisements for users.

In the example shown in FIG. 3, the customer has selected a template 26 entitled “Disco” which has a look and feel desired by the customer for his particular establishment. For example, the customer owns a nightclub named “Chez 1” and intends to display advertisements in the nightclub to his clientele. Following an initial interview with the customer, including a visit to the customer's nightclub, a determination of the time of day that the customer intends to display the advertisement, and the target audience who will view the advertisement, an administrative user of the present invention generates a template 26 for the customer. As indicated by the selected radio button 28, the customer has selected the Disco template 26, and proceeds to generate the advertisement, for example, by selecting radio button 28.

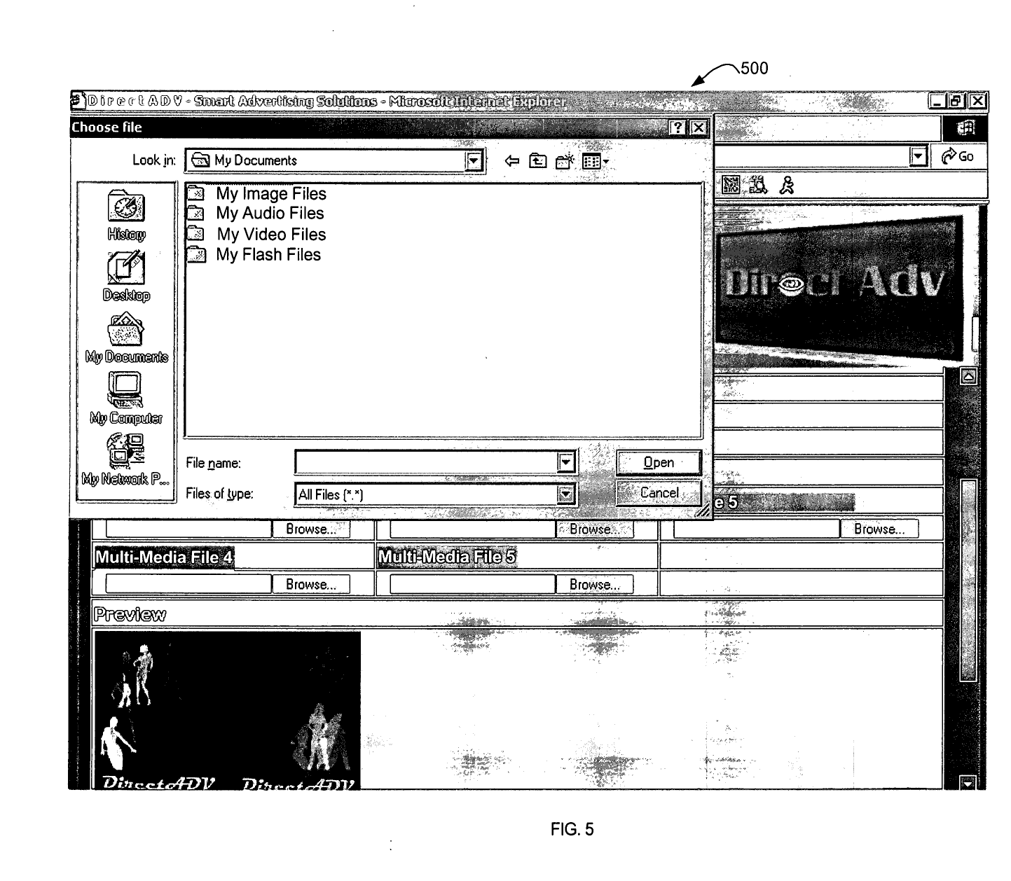

FIG. 4 shows an example display screen 400 that is preferably displayed to a customer after a template 26 has been selected (FIG. 3). Display screen 400 is preferably a data entry from that enables a user to create a customized advertisement via template 26. For example, in name section 34, the customer assigns a name to the advertisement (shown in FIG. 4 as “FIRST ADVERTISEMENT”). In text section 36, the customer can add customized text to the advertisement. In the example shown in FIG. 4, the customer has added the language “COME DANCE AT CHEZ 1.” In multi-media upload section 38, the customer selects content (e.g., digital still image, audio and/or digital moving image files) that is stored on the customer's local computer, or, alternatively, can be identified over a computer network. The ability for the customer to insert multi-media content is described in greater detail below, with reference to FIG. 5.

After the user has named the advertisement, inserted appropriate text and multi-media content, the customer preferably previews the advertisement via preview section 40. Following a preview of the advertisement, the customer can determine whether modifications, insertions or deletions would be appropriate.

In accordance with a preferred embodiment, a customer can design a plurality of advertisements. In accordance with a preferred business model, a customer may pay a flat fee during a predetermined period of time (e.g., one month) for a maximum number of templates. Any additional templates 26 provided for the customer over the maximum number may cost an additional amount. Of course, one skilled in the art will recognize that many different business models can be employed by users of the present invention without departing from the teachings herein. For example, rates may be charged to a customer for each template 26 that is generated in accordance with the teachings herein. Alternatively, customers may pay for a period of time that an advertisement is displayed to an audience. Moreover, customers may pay for a maximum number of templates 26, such as three. If a customer desires more than the maximum number of templates, then the customer may pay additional fees. In an alternative embodiment, new templates may be provided at no extra charge to the customer on a regular basis, such as monthly, semi-annually or annually. Customers may request new or revised templates 26 periodically.

Preferably, a customer selects a graphical screen control, such as a drop-down list, to indicate that a particular advertisement generated in accordance with the teachings herein is to be available for display to an audience. Referred to herein, generally, as an advertisement being “active,” active control 41 is preferably selected by the customer to indicate that a respective advertisement is displayable, for example, on one or more monitors 5. In addition to selecting an advertisement to be active, a user selects in date/time section 42, the particular day(s) of the week and time(s) during the day when the customer wants the advertisement displayed. After the user identifies an advertisement as being active or inactive, the user preferably selects save/don't save button 43 in order to save the advertisement for future use.

FIG. 5 illustrates an example display screen 500 that is provided to a customer who is uploading content to be incorporated in an advertisement after selecting an icon (or other control) to upload content via multi-media upload section 38 (FIG. 4). One skilled in the art will recognize that the display shown in FIG. 5 is provided in part as a function of a local computer operating system (e.g., WINDOWS and/or MAC) and enables the customer to navigate his local hard drive and any other drive in which the customer has corresponding rights (e.g., network drives) to select and upload multi-media content. After navigating to a particular file the user wishes to include in an advertisement, the user preferably selects the file and the file is substantially automatically uploaded to information processor 2 for integration in the advertisement.

Although the example shown in FIG. 5 identifies the MICROSOFT WINDOWS operating system, the invention is not so limited. As noted above, any suitable operating system and/or known in the art is envisioned herein for operating user terminal 4 and employing the teachings herein. For example, the UNIX operating system, PALM OS, POCKET PC OS, LINUX operating system, OSX operating system or the like may provide access to multimedia content for uploading to information processor 2 and for integration in an advertisement.

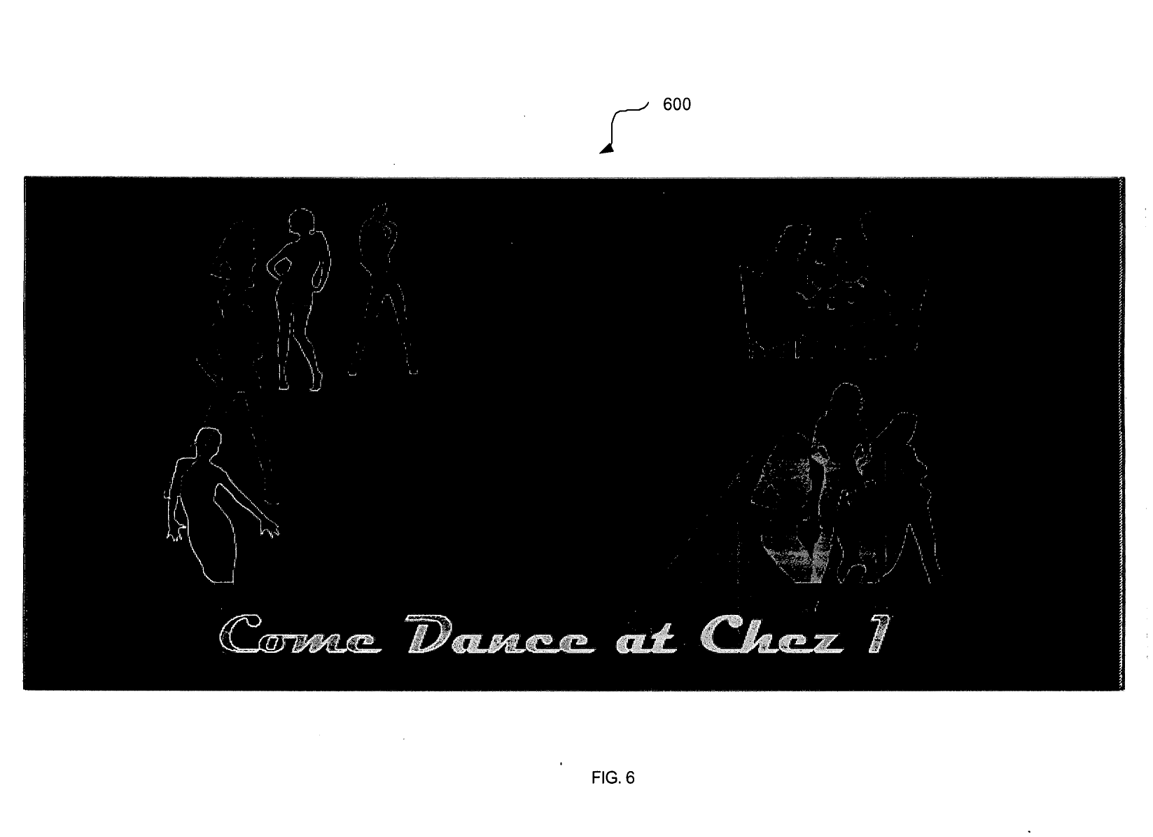

FIG. 6 illustrates and example display screen 600 that shows an example advertisement that is provided in accordance with the teachings herein. In the example shown in FIG. 6, the customer has completed his advertisement for his nightclub (“Chez 1”) and the advertisement includes customized text from text section 36 (e.g., “COME DANCE AT CHEZ 1”).

A brief summary of some technical features of a preferred embodiment is now provided below.

In a preferred embodiment, templates 26 are provided as MACROMEDIA FLASH (“SWF”) files and are operable, for example via MACROMEDIA ACTION SCRIPT or its equivalent in order to provide animated graphic and video content over a communication network, such as the internet. The SWF is preferably organized in the FLASH frames time bar, as known to one skilled in the art.

After the user selects content to be included in the template 26, the picture files, audio files and/or video files are integrated, combined, displayed and/or provided on monitor 5. In a preferred embodiment, parameters are transmitted by the information processor 2 to template 26, and template 26 requests data (described above) from template database 8.

In a preferred embodiment, internet security is provided such that access to information processor 2 and/or associated web sites, databases or the like is restricted to authorized users. Preferably, customers, administrative users and other parties receiving access to restricted portions of information processor 2 and/or corresponding web sites or the like are provided with a user name and/or password that, when received, provides appropriate authorization. Preferably, each time user logs in, the system 10 remembers the user and provides one or more templates selected/defined/used by the user.

When a template 26 is generated, for example, by an administrative user, system 10 preferably assigns a corresponding identifier for the template 26. Moreover, the template 26 identifier enables system 2 to select and/or retrieve a corresponding template 26 with an appropriate user, such as a customer. For example, when a customer provides his authorized user name and password, the template(s) associated with the customer are automatically selected and/or retrieved by system 2.

Although the present invention is described in as an implementation using various development tools and environments, such as MACROMEDIA FLASH, ACTIVE SERVER PAGES, MS-ACCESS, JAVA SCRIPT, ACTION SCRIPT and/or SWISH, one skilled in the art will recognize that other embodiments are possible, such as JAVA, SQL or the like.

In one embodiment, FLASH/SWISH is used to make templates 26 load dynamic pictures, movies, audio and text. ACTION SCRIPT is used to in the Flash/Swish files to retrieve information from an ACTIVE SERVER PAGE file to the SWISH/FLASH. JAVA SCRIPT and ACTION SCRIPT is preferably used to determine the date and time and to resize windows to enable full-screen previews and displays. HTML is preferably used to write web pages in. ACTIVE SERVER PAGES is used read/write data to information processor 2, and to manage system administrative and customer side access. ODBC is used to connect ACTIVE SERVER PAGES to database files, and SQL SERVER compatible tables (e.g., MS-ACCESS tables) are used to store data. One skilled in the art will recognize the abbreviations and trademarks used above. Further, one skilled in the art will recognize that the above is representative of a particular embodiment of the invention, and is not meant to limit or restrict the invention thereto.

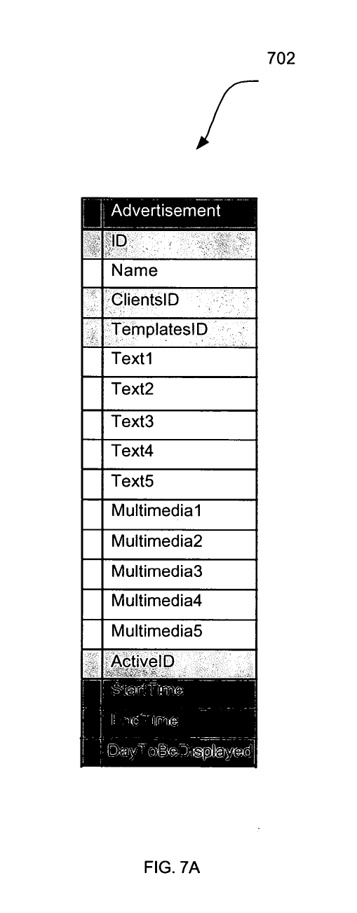

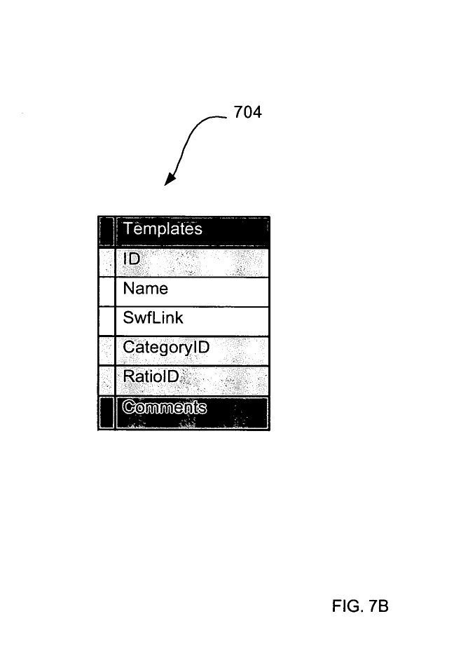

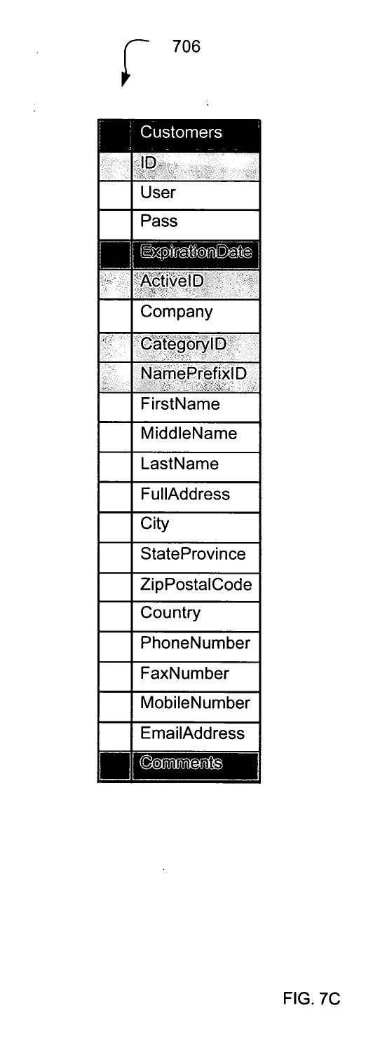

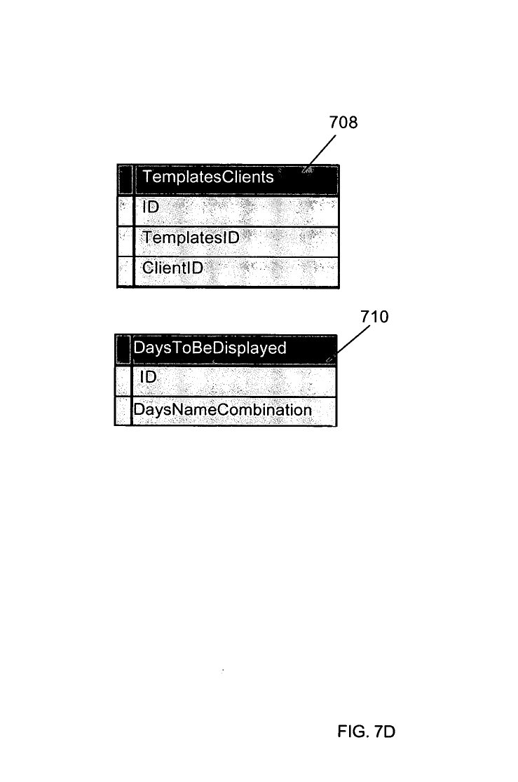

FIGS. 7A-7D illustrate example table structures that are used in an embodiment, and described below. The table structures and corresponding descriptions below are meant to be merely illustrative, and not to limit the present invention to any one particular embodiment.

FIG. 7A illustrates advertisement table 702 and contains seventeen data fields. As shown in FIG. 7A, the following data fields represent the following data:
ID represents: the raw Number.
Name represents: the Screen name(by the customer).
ClientsID represents: the Customer ID number that using this screen.
TemplatesID represents: the Template ID number that been used in this screen.
Text1 represents: the first text the customer can insert to his advertisement.
Text2 represents: the second text the customer can insert to his advertisement.
Text3 represents: the third text the customer can insert to his advertisement.
Text4 represents: the four Text the customer can insert to his advertisement.
Text5 represents: the fifth Text the customer can insert to his advertisement.
Multimedia1 represents: the First file name that a customer can insert to his advertisement.
Multimedia2 represents: the second file name that a customer can insert to his advertisement.
Multimedia3 represents: the Third file name that a customer can insert to his advertisement.
Multimedia4 represents: the Four file name that a customer insert to his advertisement.
Multimedia5 represents: the Fifth file name that a customer can insert to his advertisement.
ActiveID represents: the advertisement is displayed at the screen (yes\no).
StartTime represents: Start Time between the advertisements will be displayed.
EndTime represents: End Time between the advertisements will be displayed.
DayToBeDisplayed represents: the day(s) that the advertisement will be displayed.

FIG. 7B illustrates templates 26 table 704 and contains six data fields. As shown in FIG. 7B, the following data fields represent the following data:
Templates represents a graphic template description
ID represents: the Template ID number.
Name represents: the template name.
SwfLink represents: the path and file name of the template
CategoryID represents: from the Category table choose the category on template belongs.
RatioID represents: the display device ratio.
Comments represents: any administrative user comment for the template.

FIG. 7C illustrates customers table 706 and contains twenty-one data fields. As shown in FIG. 7C, the following data fields represent the following data:
Customers represents: Customers Details.
ID represents: the customer raw ID number.
User represents: the username the customer will us to his logins.
Pass represents: the password the customer will us to his logins.
ExpirationDate represents: the Expiration date for the customer to become not active. (If not active the customer won't be able to view his advertising on full screen.).
ActiveID represents: the Customer active (yes\no).
Company represents: the Customer company name.
CategoryID represents: from the category table, the customer category of business.
NamePrefixID represents: Mr./Mrs./Miss.
FirstName represents: the Customer first name (in case of a company the name of the contact).
MiddleName represents: the Customer middle name (in case of a company the name of the contact).
LastName represents: the Customer last name (in case of a company the name of the contact).
FullAddress represents: the customer full address.
City represents: the customer city.
StateProvince represents: the customer state.
ZipPostalCode represents: the customer zip code.
Country represents: the customer country.
PhoneNumber represents: the customer phone number.
FaxNumber represents: the customer fax number.
MobileNumber represents: the customer mobile number.
EmailAddress represents: the customer Email address.
Comments represents: comments regarding the customer.

FIG. 7D illustrates an example shared customers to templates table 708 and contains three data fields. Also in FIG. 7D is an example dates to be displayed template table 710. As shown in FIG. 7D, the following data fields represent the following data:
TemplatesClients represents: a respective template to be used by a respective customer.
ID represents: the ID number.
TemplatesID represents: the template ID number.
ClientID represents: the Customer Id number.

With regard to the data fields in table 710, the following data fields represent the following data:
ID represents: the ID number.
DaysNameCombination represents: a combination of days to display an advertisement.

Thus, the tables structures displayed in FIGS. 7A-7D enable storage of data related to customers, templates 26, advertisements and various other sources described herein.

The present invention is now further described with reference to examples embodiments.

In a first example, a clothing store employs the teachings herein, and positions a plurality of monitors 5 throughout the store in many different positions. Some monitors 5 are large, while others are relatively small, in order to accommodate various locations and contexts within the store. Further, some monitors 5 are located such that consumers in the store can easily see the monitors, while other monitors 5 are positioned such that passersby outside can easily see the monitors 5. The latter positioned monitors 5 persuade passersby to enter the store.

Continuing with the present example, the monitors 5 throughout the store show respective advertisements for particular contexts. For example, a monitor 5 positioned in the women's shoe department section of the store are programmed to display advertising content directed to handbags and purses. Moreover, the monitors 5 located in the men's suit department are programmed to display briefcases, ties and shoes. Moreover, when a new product line is introduced in the store, a representative uses the present invention to efficiently update the advertisement content displayed on respective monitors 5.

The nature of the invention is such that content can be easily revised, updated on demand, substantially in real time. Store managers can ensure that advertising content is current, fresh and particular to any audience. For example, on a day in which a particular sale on a particular product or product line is occurring, the monitors 5 can show content directed to that product or product line. When the sale is over, the advertising content displayed on monitors 5 can be updated to reflect previous advertising content, or new advertising content.

In a second example, a restaurant employs the teachings herein and installs a plurality of monitors 5 in the restaurant. One or more monitors 5 is used to introduce the restaurant clientele to daily specials. Images, movies and/or written descriptions can be displayed to entice consumers to purchase a daily special. Moreover, as people are eating, monitors 5 can display desserts, after-meal drinks, or the like.

In yet a third embodiment, a dance nightclub employs the teachings herein, and has a plurality of monitors 5 installed in the nightclub. Digital movie cameras are used to capture motion pictures of the nightclub's clientele. Operators in the nightclub upload the digital image/movie files to information processor 2, and substantially in real time, the nightclub's clientele can view themselves on the monitors 5. Moreover, a plurality of templates 26 can be used to display creative and unique views of the nightclub and its clientele.

Countless other uses of the present invention are envisioned herein. For example, the invention is applicable to sporting events, music events and other large venue events, such that stars and/or audiences can view advertising or other forms of digital content on monitors 5 during a game or performance.

Thus, although many of the examples described herein regard advertising, the invention is not so limited. Continuing with the example of the clothing store, store clientele may desire to see themselves wearing a particular outfit without using a mirror. Using the present invention, store proprietors can enable store patrons to view themselves on large monitors 5 in attractive and clever templates.

Other uses and products provided by the present invention will be apparent to those skilled in the art. Although the present invention has been described in relation to particular embodiments thereof, many other variations and modifications and other uses will become apparent to those skilled in the art. For example, the content does not have to be advertising. It is preferred, therefore, that the present invention not be limited by the specific disclosure herein.

What is claimed is:

1. A method for composing an advertisement, the method comprising:
storing on an information processor an advertisement template file operable to incorporate content received from a user of the advertisement;
providing a user interface operable for the user to transmit content to the information processor to be included in the advertisement template file for the advertisement, preview the advertisement, and/or save the advertisement;
receiving from a user the content to be included in the advertisement;
storing the received content on the information processor;
incorporating the content in the template to generate the advertisement; and
providing the advertisement on a display device such that the advertisement is available for display substantially immediately.

2. The method of claim 1, further comprising enabling the information processor and a user terminal to communicate interactively over a communication network.

3. The method of claim 2, wherein the communication network is the internet.

4. The method of claim 1, wherein the advertisement is provided to a display device via a TCP/IP communication session.

5. The method of claim 1, further comprising providing the advertisement to a plurality of display devices simultaneously.

6. The method of claim 1, further comprising providing a plurality of respective advertisements to a plurality of respective display devices simultaneously.

7. The method of claim 1, further comprising storing on the information processor a plurality of advertisement template files, wherein the user interface is operable for the user to select respective advertisement template files and transmit respective content for the respective advertisement template files thereby providing respective advertisements.

8. The method of claim 1, wherein the content comprises text, an graphic file, a sound file, and/or a moving image file.

9. The method of claim 1, wherein the user interface is further operable for the user to save the template with the content.

10. The method of claim 9, wherein the user interface is further operable for the user to add content to the saved template.

11. The method of claim 1, wherein the user interface is not operable for the user to modify the template beyond adding content.

12. The method of claim 1, wherein the user interface is further operable for a user to browse and select content from a user workstation operated by the user.

13. The method of claim 1, further comprising receiving from the user at least one of a description of a location where the advertisement will be displayed, a description of a good or service that will be advertised, a description of an audience that will view the advertisement, and a description of when the advertisement will be displayed.

14. The method of claim 13, wherein a design for the advertisement template file is based on the at least one descriptions.

15. The method of claim 1, wherein the advertisement comprises moving images that change over a predetermined period of time.

16. The method of claim 1, wherein the advertisement is provided without human interaction.

17. A system for composing an advertisement, the system comprising:
an information processor operable to store an advertisement template file that is operable to incorporate content received from a user;
a user interface operable for the user to select the advertisement template file, transmit content to the information processor to be included in the advertisement template file for the advertisement, preview the advertisement and/or save the advertisement;
a content receiving module operable to receive from a user the content to be included in the advertisement and to store the content on the information processor;
a template content integration module operable to incorporate the content in the template to generate the advertisement; and
a display module operable to provide the advertisement on a display device such that the advertisement is available for display substantially immediately.

18. The system of claim 17, further comprising a communication network over which the information processor and a user terminal communicate interactively.

19. The system of claim 18, wherein the communication network is the internet.

20. The system of claim 17, wherein the advertisement is provided to a display device via a TCP/IP communication session.

21. The system of claim 17, wherein the display module is further operable to provide the advertisement to a plurality of display devices simultaneously.

22. The system of claim 17, wherein the display module is further operable to provide a plurality of respective advertisements to a plurality of respective display devices simultaneously.

23. The system of claim 17, wherein the user interface is further operable to receive a request from the user for a new advertising template file.

24. The system of claim 17, further comprising a plurality of advertisement template files stored on the information processor, wherein the user interface is operable for the user to select respective advertisement template files and transmit respective content for the respective advertisement template files thereby providing respective advertisements.

25. The system of claim 17, wherein the content comprises text, an graphic file, a sound file, and/or a moving image file.

26. The system of claim 17, wherein the user interface is further operable for the user to save the template with the content.

27. The system of claim 26, wherein the user interface is further operable for the user to add content to the saved template.

28. The system of claim 17, wherein the user interface is not operable for the user to modify the template beyond adding content.

29. The system of claim 17, wherein the user interface is further operable for a user to browse and select content from a user workstation operated by the user.

30. The system of claim 17, further comprising an algorithm operable to generate the advertisement template file based on at least one of a description of a location where the advertisement will be displayed, a description of a good or service that will be advertised, a description of an audience that will view the advertisement, and a description of when the advertisement will be displayed.

31. The system of claim 30, wherein a design for the advertisement template file is based on the at least one descriptions.

32. The system of claim 17, wherein the user interface is further operable for a user to select a plurality multi-media content, and for the plurality of multi-media content to be provided in a sequentially in the advertisement.

33. The system of claim 17, wherein the user interface is further operable for a user to select a plurality of advertisement template files to provide sequentially a plurality of advertisements.

34. A method of generating revenue, the method comprising
charging a customer a fee to compose an advertisement;
storing on an information processor an advertisement template file operable to incorporate content received from the customer;
providing a user interface operable for the customer to select the advertisement template file, transmit content to the information processor to be included in the advertisement template file for the advertisement, preview the advertisement, and/or save the advertisement;
receiving from a customer the content to be included in the advertisement;
storing the received content on the information processor;
incorporating the content in the template to generate the advertisement; and
providing the advertisement on a display device such that the advertisement is available for display substantially immediately.

35. The method of claim 34, wherein the fee includes payment for a fixed number of advertisement template files, and an additional fee is charged for an additional advertisement template file.
